(19) United States
(12) Patent Application Publication
(10) Pub. No.: US 2026/0254188 A1
(43) Pub. Date: Aug. 27, 2026

(54) FIBER LASER SYSTEMS AND TECHNIQUES

(71) Applicant: Massachusetts Institute of Technology, Cambridge, MA (US)

(72) Inventors: John Kyungbum Kim, Boxborough, MA (US); Kelsey D. Johnsen, Medford, MA (US); Michael S. Riley, Waltham, MA (US); Luis F. Ortega, Arlington, MA (US)

(73) Assignee: Massachusetts Institute of Technology, Cambridge, MA (US)

(21) Appl. No.: 19/548,291

(22) Filed: Feb. 24, 2026

Related U.S. Application Data
(60) Provisional application No. 63/762,196, filed on Feb. 24, 2025.

(51) Int. Cl. H01S 3/067; H01S 3/094; H01S 3/0941; H01S 3/16

(52) U.S. Cl. CPC H01S 3/06729; H01S 3/06716; H01S 3/094003; H01S 3/094076; H01S 3/09415; H01S 3/1618

(57) ABSTRACT

Described herein is a pulsed fiber laser system comprising: a seed laser configured to generate signal light comprising optical pulses; and a pump signal combiner configured to receive the signal light via at least a first fiber and configured to optically combine the signal light within the at least first fiber with pump light; a gain stage comprising one or more fiber amplifiers connected by at least a second fiber; and an encapsulated splice assembly optically coupling the at least first fiber to the at least second fiber.

### CROSS-REFERENCE TO RELATED APPLICATIONS

This application claims the benefit under 35 U.S.C. § 119 of U.S. Provisional Patent Application No. 63/762,196 filed on Feb. 24, 2025, which is incorporated herein by reference in its entirety.

### STATEMENT REGARDING FEDERALLY SPONSORED RESEARCH

This invention was made with government support under FA8702-15-D-0001 awarded by the U.S. Air Force. The government has certain rights in the invention.

### BACKGROUND

Fiber lasers are a class of lasers in which the active gain medium is an optical fiber. The fiber can be doped with one or more rare-earth elements, such as Ytterbium. Fiber amplifiers allow for laser technology to be integrated into Size Weight and Power (SWAP) compliant forms for deployable systems for various applications.

Pulsed fiber lasers are a type of fiber lasers that emit light in the form of optical pulses, in contrast to continuous mode. Pulsed fiber lasers find use in many different types of systems and applications, including but not limited to sensing applications such as Light Detection and Ranging (LIDAR), 3D imaging and mapping, satellite-based terrain monitoring, free space optical communications, and various other sensing and communications applications.

### SUMMARY

Certain applications of pulsed fiber lasers necessitate a tightly constrained output spectrum. Pulsed fiber lasers may include one or more amplification stages (e.g., fiber amplification devices). The process of pulse amplification through multi-staged fiber amplifiers effectively enhances the peak power of optical pulses. However, the interaction of these amplified optical pulses with the optical fiber in the amplifiers leads to an augmentation in fiber nonlinearities. Consequently, the spectral bandwidth of the amplified optical pulses undergoes expansion. According to one aspect of the present disclosure, systems and techniques are provided for achieving elevated peak power in pulsed fiber lasers, while mitigating the issue of substantial spectral broadening.

One of the critical components found in fiber amplifier systems is fusions splices that carry kilowatts of pump and signal light into gain stages. According to another aspect of the present disclosure, a fusion splice process and assembly is provided to allow for the encapsulation of a splice between a kW-class multimode combiner and Ytterbium-doped fiber. The ability to encapsulate these splices and package them into robust mechanicals allows for the ruggedization needed for fielded applications. The potential impacts for this encapsulation process and splice assembly are vast as many current products employ splice techniques that have been shown to fail in certain environments. The disclosed fusion splice process and assembly can also be used within combined amplifier systems, meaning systems having multiple fiber amplifiers where the optical outputs are coherently or spectrally combined.

Pulse generation by direct current modulation of semiconductor lasers is important for seeding pulsed fiber laser amplifiers. This approach to pulse generation is low in complexity, size, maintenance and cost when compared to external modulation. However, it can come with certain compromises for the system in development. One of these compromises is the presence of a gain-switching peak at the leading edge of the optical pulse output. According to another aspect of the present disclosure, a technique is provided for improving the output pulse shape of a semiconductor laser created by direct current modulation by suppressing the gain-switching peak seen on ns-class (ultra narrow high voltage pulse) and longer pulses.

Optical nonlinearities are a limiting factor in pulsed fiber laser peak power scaling. These effects include Stimulated Brillouin Scattering (SBS), Stimulated Raman Scattering (SRS), Four-Wave Mixing (FWM), and Amplified Spontaneous Emission (ASE), and can result in consequences ranging from decreased laser performance to damage to the system.

The accumulated nonlinear phase shift in the fiber laser can be described by the B-integral:

$$B = \frac{2 π}{λ} \int {n}_{2} I ( z )$$

where λ is the wavelength of the signal, n₂ is the nonlinear index of the fiber, and I(z) is the intensity of the light in the fiber as a function of fiber length. Peak power handling of the fiber amplifier can be increased by managing the intensity×length product in the B-integral.

According to another of the present disclosure, techniques are described for reducing, and ideally eliminating, nonlinearities in a pulsed fiber laser system. In more detail, disclosed techniques for gain fiber selection, fiber length and input power optimization, and pulse shaping may be applied to reduce nonlinearities.

In some embodiments, a pulsed fiber laser system comprises: a seed laser configured to generate signal light comprising optical pulses; and a pump signal combiner configured to receive the signal light via at least a first fiber and configured to optically combine the signal light within the at least first fiber with pump light; a gain stage comprising one or more fiber amplifiers connected by at least one second fiber; and an encapsulated splice assembly optically coupling the at least first fiber to the at least one second fiber.

The pump signal combiner can comprise a kW-class multimode combiner. The at least one second fiber can comprise Ytterbium-doped active fiber. The encapsulated splice assembly can be formed of metal. The metal can be coated with a chemical film. The encapsulated splice assembly can comprise: a top portion; a bottom portion configured to be fastened to the top portion, the bottom portion including a u-shaped channel to receive the at least first fiber and the at least one second fiber; and a rectangular channel disposed above the u-shaped channel, the rectangular channel filled with a low-index recoat material.

The seed layer can include a driver configured to generate electrical pulses and at least one laser diode configured to generate optical pulses in response to the electrical pulses. The gain stage can be configured to amplify the optical pulses. The electrical pulses can be shaped to suppress gain-switching peaks within the optical pulses. The electrical pulses can have a pedestal on their leading edges. The pedestal can have a slope (M) and a voltage level (L) at which the pedestal intersects a base of the electrical pulses. M and L can be optimized for the suppression of the gain-switching peaks within the optical pulses. The seed laser can be configured to reduce spectral broadening within the optical pulses.

In some embodiments, a trench fiber can comprise a core to carry signal light and a cladding to carry pump light. An index of refraction of the cladding can be depressed in a region around a diameter of the core. The trench fiber may be included within the one or more fiber amplifiers of the system described above. The depressed region of the cladding can be doped to have a lower index of refraction compared to other regions of the cladding. The diameter of the core can be tapered along a length of the trench fiber. The core can be doped with phosphorous.

In some embodiments, a method for optically coupling a first fiber to a second fiber can include: forming a strip interface on both the first fiber and the second fiber; performing a pre-splice cleaning to remove residual coating and contaminates from both the first fiber and the second fiber; splicing the first fiber to the second fiber at their respective strip interfaces to provide a spliced fiber; performing a post-splice cleaning to remove contaminates from the spliced fiber resulting from the splicing; recoating at least a portion of the spliced fiber using a recoat material; encapsulating the spliced fiber within an encapsulated splice assembly; and backfilling at least a portion of the spliced fiber within the encapsulated splice assembly using the recoat material.

The first fiber and/or the second fiber can have a low-index fiber recoat material, such as fluoroacrylate coating. The forming of the strip interface on the first fiber and/or the second fiber can leave the fluoroacrylate coating structurally intact around a diameter of the first fiber and/or the second fiber. The splicing of the first fiber to the second fiber can comprise using a splice machine with a recipe to both: maintain waveguide properties the first and second fiber for signal propagation; and enable pump propagation through a junction of the spliced fiber. The recoat material can comprise low-index material such as fluoroacrylate. The performing of the post-splice cleaning can include wiping bare glass of the spliced fiber with one or more solvents, such as Acetone, Ethanol, and/or Methanol. In some cases, all three of these solvents can be used.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a schematic diagram of a pulsed fiber laser system in which embodiments of the present disclosure may be utilized.

FIG. 2A is a plot diagram illustrating spectral power of a first seed laser that may be used within a pulsed fiber laser system.

FIG. 2B is a plot diagram illustrating spectral power that may be output by the pulsed fiber system using the first seed laser of FIG. 2A.

FIG. 3A is a plot diagram illustrating spectral power of a second seed laser that may be used within a pulsed fiber laser system.

FIG. 3B is a plot diagram illustrating spectral power output by the pulsed fiber system using the second seed laser of FIG. 3A.

FIG. 4 is a schematic diagram showing components of a fiber laser system optically coupled using a kilowatt-class encapsulated splice, according to some embodiments of the present disclosure.

FIG. 5A is a photograph of an optical fiber stripped using an automated mechanical optical fiber buffer jacket removal machine.

FIG. 5B is a photograph of optical fiber splice formed using techniques disclosed herein.

FIG. 6 is a perspective view of encapsulated splice assembly having a top portion and a bottom portion, shown here assembled together.

FIG. 6A is a perspective view showing the top portion of the encapsulated splice assembly base of FIG. 6.

FIG. 6B is a perspective view showing the bottom portion of the encapsulated splice assembly base of FIG. 6.

FIGS. 6C-E are schematic drawings showing details of the encapsulated splice assembly base of FIG. 6.

FIGS. 7A and 7B are plot diagrams respectively illustrating an electrical pulse (input) and resulting optical pulse (output) generated using direct-current modulation.

FIGS. 8A and 8B are plot diagrams illustrating different electrical pulse waveforms used to generate optical pulses with direct-current modulation, the waveforms designed for gain switching peak suppression, according to embodiment of the present disclosure.

FIG. 9 is a plot diagram illustrating different optical pulses that may result from different electrical pulse waveforms designed for gain switching peak suppression.

FIG. 10 is a cross-sectional view (profile) of a trench fiber that may be provided within a pulsed fiber laser system.

FIG. 11 is a schematic illustration of a trench fiber having a tapered design, according to some embodiments.

FIG. 12 is a plot diagram showing signal and pump power within a trench fiber having a tapered design as in FIG. 11.

FIG. 13A is a plot diagram illustrating an electrical pulse that can be applied to a seed laser driver.

FIG. 13B is a plot diagram illustrating an optical pulse that can be output by a seed laser in response to the electrical pulse of FIG. 13A.

FIG. 13C is a plot diagram illustrating an amplified pulse that can result from amplification of the optical pulse of FIG. 13B using a trench fiber having a tapered design as in FIG. 11.

The drawings are not necessarily to scale, or inclusive of all elements of a system, emphasis instead generally being placed upon illustrating the concepts, structures, and techniques sought to be protected herein.

### DETAILED DESCRIPTION

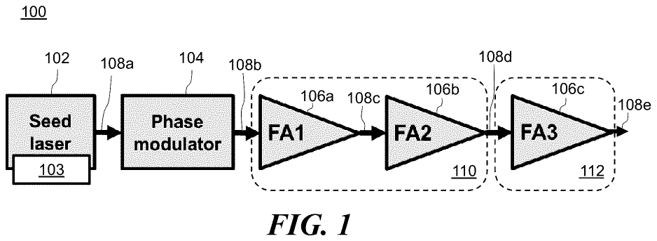

FIG. 1 shows a pulsed fiber laser system in which embodiments of the present disclosure may be utilized. Illustrative system 100 includes a seed laser 102, a phase modulator 104, and a plurality of fiber amplifiers 106a, 106b, 106c (106 generally). The laser system components 102, 104, 106, and 108 are optically coupled together by fiber segments 108a, 108b, 108c, and 108d, as shown.

An additional fiber segment 108e can be connected to an output of fiber amplifier 106c and correspond to an output of the fiber laser system 100. In some examples, system 100 can include a transition from fiber (e.g., from segment 108e may) to free space/air. For example, an end cap may be disposed at the distal end of fiber segment 108e. The end cap can have an elongated cylindrical shape. In one example, the glass cap may be approximately 10-15 mm long and have a diameter of approximately 2 mm. In some examples, the end cap may be formed of glass. One side of the end cap can have a flat surface and the other side can have an angular surface. The surfaces can be formed using a grinding and/or polishing technique. An antireflection dielectric coating can be applied on the angled side to minimize band reflection. The end cap ca be fused to fiber using an arc welding (or “fusion splicing”) technique.

Seed laser 102 can generate optical (i.e., light) pulses of a given duration (e.g., five nanosecond pulses) and/or at a given frequency (e.g., 200 kilohertz), sometimes referred to as a repetition rate. In some embodiments, seed laser 102 may include a distributed feedback semiconductor laser (e.g., a laser diode), precisely operated in a pulsed configuration.

Seed laser 102 can include or otherwise be coupled to a seed laser driver 103 configured to generate pulses having a particular waveform and to apply those pulses to the laser diode. In some embodiments, seed laser driver 103 can perform direct current modulation, such as discussed later in the disclosure. Seed laser driver 103 can include RF electronics that push high currents to the laser diode in order to create optical pulses. In general, any fast laser driver with a user-programmable pulse shape capability may be used.

Phase modulator 104 can receive the optical pulses generated by seed laser 102 and subject them to phase modulation. In more detail, phase modulator 104 can combine (e.g., sum) multiple pulses to such that modulated optical pulses output by phase modulator 104 have a wider optical spectrum compared to the pulses generated by seed laser 102. This can be done, for example, to reduce the effects of Brillouin Scattering.

The modulated optical pulses undergo a process of amplification through a sequence of optically coupled fiber amplifiers 106, resulting in an intensified output of the fiber laser system 100. As shown, fiber amplifiers 106 may be arranged serially (i.e., in stages) such that the output of amplifier 106a is provided as input to amplifier 106b, the output of amplifier 106b is provided as input to amplifier 106c, etc., and the output of the final stage amplifier 106c provides the output of the pulsed laser system 100 (via segment 108e). In some embodiments, amplifiers 106a and 106b may collectively be configured to function as a preamplifier stage 110, whereas amplifier 106c may be configured to function as a high-power gain stage 112 (i.e., to amplify the signal to a high power). In some examples, amplifier 106c (FA3) may comprise a trench fiber amplifier. While system 100 of FIG. 1 is shown as having a 3-stage fiber amplifier, the general concepts and techniques disclosed herein can be used in conjunction with a pulsed fiber laser system having other numbers and/or arrangements of fiber amplifiers.

Illustrative system 100 can provide pulse energy output having average power sufficiently high for many types of applications including but not limited to LIDAR, satellite-based terrain monitoring/sensing, free space optical communications, etc.

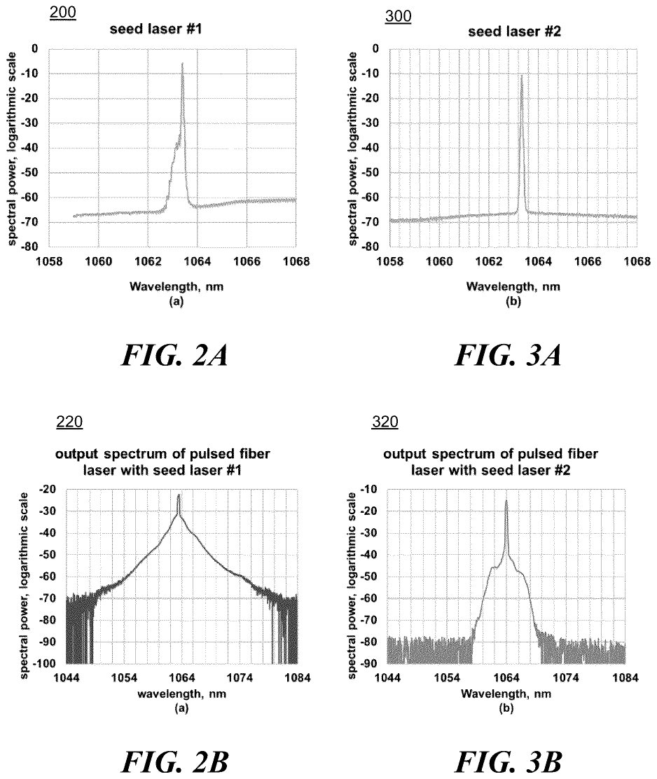

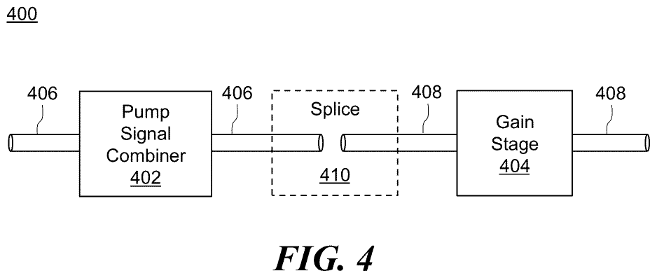

Turning to FIGS. 2A, 2B, 3A, and 3B, it is appreciated herein that the output spectrum of the seed laser within a pulsed fiber laser system has a substantial effect on the output spectrum of the system. The process of pulse amplification through multi-staged fiber amplifiers effectively enhances the peak power of optical pulses. However, the interaction of these amplified optical pulses with the optical fiber in the amplifiers leads to an augmentation in fiber nonlinearities. Consequently, the spectral bandwidth of the amplified optical pulses undergoes expansion. Thus, the choice of seed laser may be critical for applications requiring a tightly constrained output spectrum.

In FIG. 2A, a plot 200 illustrates an optical spectrum of a first seed laser on a logarithmic scale. Plot 200 may correspond to the optical spectrum output by seed laser 102 of FIG. 1. In FIG. 2B, a plot 220 shows the output spectra of a pulsed fiber laser system resulting from use of this first seed laser. Plot 220 may correspond to the optical spectrum output the final fiber amplifier 106c in FIG. 1.

In FIG. 3A, a plot 300 illustrates an optical spectrum of a second seed laser (e.g., output of seed laser 102 in FIG. 1) plotted on a logarithmic scale. In FIG. 3B, a plot 320 shows the output spectra of a pulsed fiber laser system (e.g., output of fiber amplifier 106c in FIG. 1) resulting from use of this second seed laser.

As can be seen in these plots, the output spectrum of the pulsed fiber laser utilizing the second seed laser (FIGS. 3A and 3B) has significantly lower degree of spectral broadening in comparison to the first seed laser (FIGS. 2A and 3B). This distinction underscores the superior performance and efficacy possible in a pulsed fiber laser system with appropriate seed laser selection. Selecting an appropriate seed laser for a pulsed fiber laser enhances peak power scalability while mitigating spectral broadening due to fiber nonlinearities. Notably, both spectra exhibit a sideband mode suppression ratio exceeding 30 dB, which may be a desirable for many applications.

It is recognized herein that different seed lasers from different vendors may produce different optical spectra. Moreover, it is possible that different seed lasers from the same vendor may produce different optical spectra, even for identical part numbers. Thus, the choice of seed laser (seed quality) is an important factor for achieving a level spectral broadening acceptable a given pulsed fiber laser application.

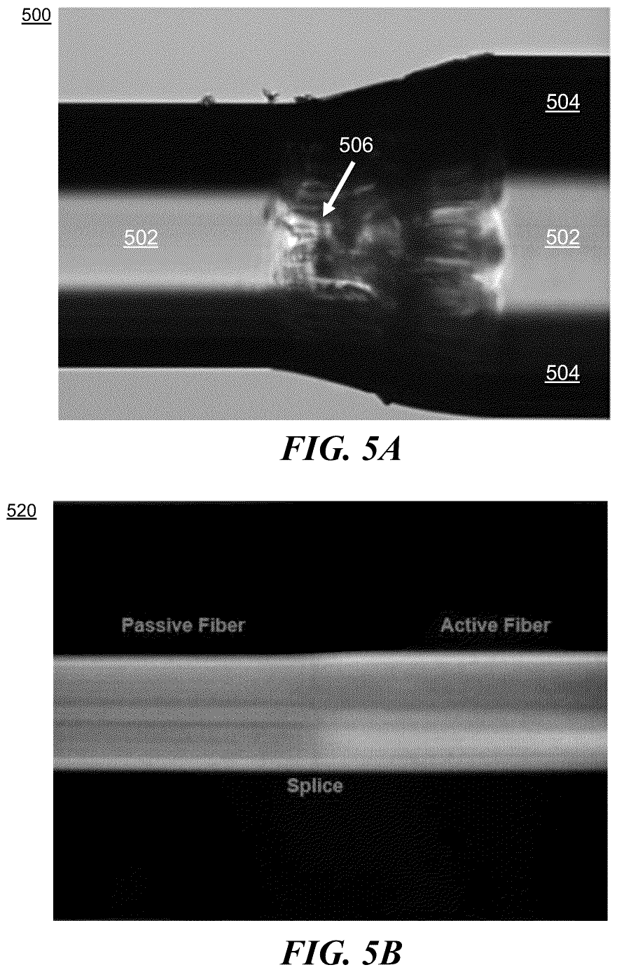

FIG. 4 illustrates components of a fiber laser system optically coupled using a kilowatt-class encapsulated splice, according to some embodiments of the present disclosure. A fiber laser system 400 can include a pump signal combiner 402, a gain stage 404, a first fiber 406, and a second fiber 408, for example, along with other system components omitted for clarity.

First fiber 406 is configured to receive light from a seed laser (e.g., a laser diode), such as seed laser 102 of FIG. 1. This light can be modulated to carry information and is thus referred to as “signal light.” In some cases (e.g., where system 400 is operated in a pulsed configuration), first fiber 406 may be optically coupled to an output of a phase modulator, such as phase modulator 104 of FIG. 1. Pump signal combiner 402 can be configured to optically pump the first fiber 406 with a second laser wavelength (“pump light”) that is coupled into the line in addition to the signal light. Both wavelengths of light are transmitted through the first fiber 406, which transfers energy from the pump light to the signal light. In some embodiments, pump signal combiner 402 may be a kW-class multimode combiner.

In some embodiments, first fiber 406 may be a double-clad fiber having three layers: an inner-most layer called the core, an inner cladding surrounding the core, and an outer cladding surrounding the inner cladding. In this arrangement, the core can guide the signal light whereas the inner cladding and core together guide the pump light.

The combined light carried on first fiber 406 (sometimes referred to as the “passive fiber”) undergoes a process of amplification through a sequence of interconnected fiber amplifiers provided with gain stage 404 that intensifies light within second fiber 408. Second fiber 408 (sometimes referred to as the “active fiber”) can be provided as a doped fiber, such as an Ytterbium-doped fiber. In some embodiments, gain stage 404 may include a plurality of fiber amplifiers optically coupled in a serial fashion, such as illustrated in FIG. 1.

Pump signal combiner 402 may be provided as a packaged fiber optic component. To optically couple this component with (doped) second fiber 408 of gain stage 404, it may be necessary to splice the first and second fibers 406, 408 together. The splicing process generally requires removing the coating from first fiber 406 in a manner that does generate scatter and heat, and provides a junction between the fibers 406, 408 that does not disrupt the optical waveguide provided thereby. Thus, particular attention must be paid to splice “recipe.” Here, “coating” refers to the outer buffer jacket that surrounds the fiber. The glass fiber can be surrounded with a protection jacket and in some cases a low index jacket followed by a buffer jacket. In some examples, these jackets can be ultraviolet curable coatings.

Current fiber amplifiers rely on suspending a kW-class splice over a mechanical cavity. The scattered light is absorbed by the surrounding metal and the splice is cooled through air-convection. Issues with this approach include: (1) the splice has no direct heat transfer path to the mechanical structure with all cooling coming from air-convection; and (2) the splice is prone to fracture due to suspension over cavity when subjected to vibration, shock and thermal cycling. This standard approach has been shown to fail when put through specific environmental stress, such as may be found in harsh environmental conditions in which fiber laser systems are deployed.

Disclosed structures and techniques provide an encapsulated splice between components of a fiber laser system, such as between a kW-class multimode combiner and doped active fiber. An example of such an encapsulated splice 410 is illustrated in FIG. 4.

According to some embodiments, an encapsulated splice may be formed using one or more of the following steps/techniques:
Forming well-defined strip interfaces whereby the fluoroacrylate coating on the fiber remains structurally intact around the diameter of the fiber.
A pre-splice cleaning process to remove all residual coating from glass and contaminates. The localized hot spots along the bare glass are what cause thermal run-away, ambering of recoat materials and splice failure.
A splice recipe that is cold enough to maintain the waveguide properties of the optical fiber for desirable signal propagation, but hot enough to enable pump propagation through the splice junction with little loss.
A post-splice cleaning process not found in state-of-the-art splicing practice. It is appreciated that the splicing process itself is a dirty process which produces scattered contamination on the bare glass.
A recoat process using a low-index fiber recoat material (e.g., low-index fluoroacrylate).
A mechanical encapsulated splice assembly that provides only a small volume to back-fill with recoat material and has sufficient thermal capacity for various applications.

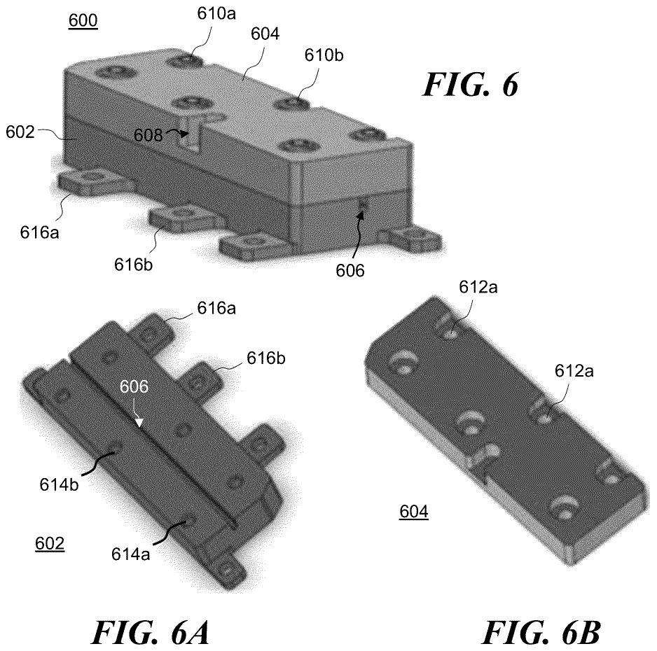

It is appreciated herein that high quality strip interfaces can be achieved using an automated mechanical optical fiber buffer jacket removal machine, such as the PCS-100 (Polyimide Coating Stripper) from AFL GLOBAL. Such a machine may employ a razor blade integrated into an actuator which removes the fiber buffer jacket as the fiber is rotated. The machine can produce an interface having a conical surface (i.e., giving the appearance of a sharpened pencil) where the low-index fluoroacrylate layer is preserved, such as shown in FIG. 5A.

FIG. 5A shows an example of an optical fiber 500 stripped using an automated mechanical optical fiber buffer jacket removal machine. In the figure, light regions 502 and dark regions 506 correspond to the outer protective buffer jacket on the fiber. Region 506 corresponds to the uniform low index jacket underneath the outer jacket. As can be seen in the figure, the removed coating jackets give the appearance of a sharpened pencil.

There are a couple reasons why this geometry is important to recoating splices where kW-class light is propagating. First, the geometry minimizes scatter which can cause a localized hot spot at the interface, ambering of recoat materials, and failure. Second, the integrity of the fluoroacrylate buffer jacket is maintained allowing for desirable guiding properties when recoat materials are applied post splicing. The inventors have found that the AFL PCS-100 can prevent failure at strip interfaces, unlike other standard techniques such as hand tools, hand-striping with a razor blade, and thermal strippers.

The particular cleaning process used for pre-splice and/or post-splice cleaning is an important factor in obtaining a desirable splice. Existing industry practices employ Isopropanol and or Acetone. Some vendors utilize ultrasonic baths with Acetone to clean splices. It is appreciated herein that existing industry practices have a high potential for leaving contamination scattered on the bare glass which will generate localized hot-spots, along with solvent staining.

According to some embodiments, a three-step cleaning process involving three different solvents may be used as an improvement over existing practices. The solvents may be wiped on or otherwise applied to the fiber. First, Acetone may be used to remove the fiber coating. Second, Ethanol may be used to remove residual Acetone. Third, Methanol, which has a very low surface tension, may be used to remove any remaining cleaning solvents off the fiber.

After an optical fiber is stripped (e.g., using the PCS-100), a post-splice cleaning process may be performed whereby the fiber is cleaned with a combination of ultrahigh purity Acetone, Ethanol, and Methanol (spectroscopy grade). The process involves wiping the stripped fiber with two wetted wipes of Acetone, two wetted wipes of Ethanol and two wetted wipes of Methanol. Ethanol has been found to be an effective solvent to remove residual Acetone, while Methanol with its low surface tension is a great final cleaning solvent. All solvents may be stored in glass bottles and applied to wipes with an eyedropper. Glass bottles may be preferable to plastic to avoid contamination through leeching of bottle materials into the solvents.

The choice of cleaning wipes used in the pre-splice and/or post-splice cleaning process is also important to obtaining a desirable splice. A standard practice is to employ KIMWIPES, but these can leave foreign object debris on the cleaned glass. Thus, in some embodiments, TEXWIPE Tx2064 polyester wipes may be used in the cleaning process. These wipes can be cut, for example, into 4-inch×4-inch squares and are cleanroom compatible.

In some embodiments, the optical fiber may be cleaved flat to within a predetermine range (e.g., less than or equal to 0.2 degrees) to minimize loss of both pump and signal, plus to preserve purity of the optical output from the fiber amplifier. Typical industry practices can be employed to achieve this standard of flatness. In some cases, a VYTRAN LDC 40p0 cleaving machine (or cleaver) can be used along with an ARDEN cleave interferometer. The cleaver's parameters can be optimized via the cleave interferometer surface flatness measurement.

In some embodiments, an optical fiber splicing machine (or “splicer”) such as the AFL FSM-100+ may be used in conjunction with a custom splice recipe developed to maintain the waveguide properties of the optical fiber along with structural continuity for pump light propagating in the outer cladding layers. Table 1 shows an example of such a splice recipe.

TABLE 1
AFL PCS-100 Recipe

| Parameter | Value | |
|---|---|---|
| Stripping Length | 35 | mm |
| Coating Diameter | 540 | um |
| Cladding Diameter | 390 | um |
| Shaving Number | 32 | |
| Blade Height | 0 | um |
| Blade Position Change Timing | 1 | |
| Stripping Speed 1 | 50 | bit |
| Stripping Speed 2 | 50 | bit |

It is recognized herein that every Ytterbium-doped optical fiber can be unique and, thus, a standard one splice recipe for all may not be sustainable from a performance perspective. Thus, in some embodiments, a splice recipe similar to that illustrated in Table 1 may be customized for a particular fiber.

A high-power electrical arc between multiple electrodes can be used to heat and melt glass fibers. The fibers can be pushed together under this arc to generate the fusion between two and slightly pulled to help with structured uniformity. There are so-called “hot” and “cold” splices. A hot splice is a splice recipe that has extremely high arc power and long arc exposure time. The glass undergoes significant melting which can affect the waveguide properties in the vicinity of the splice. A cold splice utilizes a very low arc power and short exposure time such that the fiber is heated just enough to melt the ends of the fiber and fuse everything together. It is recognized that one problem with conventional splicing is loss of pump light at the splice junction due to significant heating. This heating, while acceptable for suspended splices that are not encapsulated, can be problematic for recoating/potting a splice in a mechanical assembly. Thus, in some embodiments, a splice process somewhere between a cold and hot splice may be used.

Before splicing, the standard practice is to perform both an arc balance and calibration. The arc balance helps establish a uniform arc, while the arc calibration dials in the global arc parameter. In some embodiments, arc balancing may be performed without arc calibration. Some optical fiber splicers have a global arc parameter which controls the arc calibration or how hot the arc is to melt the glass. This process the global arc parameter can be optimized until the splice looks correct when compared to a digital picture reference, such as the splice 520 of a passive fiber 522 and an active fiber 524 shown in FIG. 5B.

Cleaning the bare glass after the splicing process can be critical to performance. Some manufacturers of splicing equipment, such as FITEL and AFL, recommend not cleaning the bare glass after the splicing process. However, the inventors recognize that a splice process can generate significant contamination on the bare glass. Thus, in some embodiments, after the splice is removed from the splicer, the bare glass can be wiped with a solvent such as Methanol. Of note, this cleaning process is separate from the previously described cleaning processes whereby residual coating on the glass is removed after stripping the fiber. Here, cleaning is performed on the glass fiber splice removed from the splicing machine.

Various recoating equipment may be used for the recoat process. For example, a THORLABS VYTRAN machine may be used. As another example, an AFL recoating machine can be employed. The low-index recoat material utilized in this process may be imperative to success. The inventors have found that a coherent recoat material, such as Coherent G001LIR, can be superior for temperature handling performance. Other recoat materials that may be used include MY POLYMERS MY-137 and FOSPIA XPC-373.

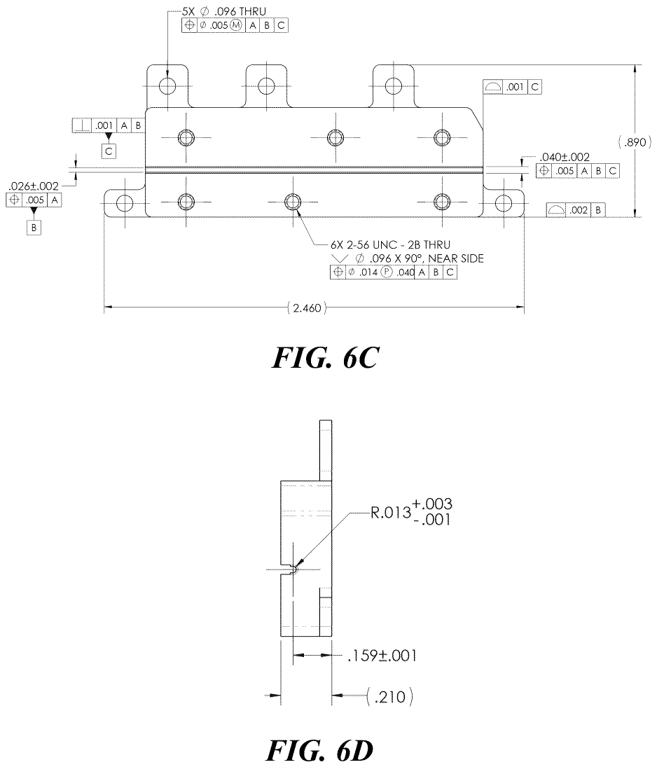

Turning to FIGS. 6A-C, after the recoating process, the recoated splice can be integrated into a splice assembly 600. In some embodiments, splice assembly 600 can include a bottom portion 602 (“base”) and a top portion 604 (“lid”) both made out of a metal (e.g., 6061 Aluminum) coated with a chemical film (e.g., Alodine coating). The bottom portion 602 can be designed to have a u-shaped channel 606 which tightly contours the optical fiber diameter so that heat transfer is obtained. A relatively small rectangular channel can be provided above the channel 606 for back fill of low-index recoat material. That is, there can be rectangular space above the fiber within the same channel 606 that is backfilled. The low-index recoat material acts as a shock absorber to reduce stress on the optical fiber, which can increase yield (e.g., when measured over significant burn-in time). The top and bottom portions 602, 604 of the splice assembly 600 can be fastened together using a plurality of fasteners (e.g., screws) 610a, 610b, etc. that extend through vias 612a, 612b, etc. formed in the top portion 604 and into corresponding receiving holes 614a, 614b, etc. formed in the bottom portion 602. A plurality of anchors 616a, 616b, etc. may be formed on the bottom portion 602 for mechanically attaching the splice assembly 600 to a support structure (not shown). Of note, the bottom portion 602 is shown in FIG. 6A rotated 180-degrees relative to FIG. 6.

FIGS. 6C-F shows details of the encapsulated splice assembly base of FIG. 6, according to some embodiments. The following notes can apply to FIGS. 6C-F:
1. MATERIAL: ALUMINUM 6061-T6; 6061-T651
2. FINISH: ELECTRO-POLISH TO REMOVE SHARP CORNERS TO 0.002 RADIUS MINIMUM; CHEMICAL FILM PER MIL-DTL-5541, TYPE I, CLASS 3, GOLD WITH ANODAL ETCH.
3. MARKING: MARK PER LL SPEC PS-7-1, CLASS XII, METHOD 4
4. CERTIFICATION: MATERIAL CERTIFICATION REQUIRED.
5. PRECISION CLEAN PER LL SPEC PS-3-21. CLEANING TO BE PERFORMED AT MIT LL.

A process for using splice assembly 600 is now described. The bottom of the splice base channel 606 can be painted with a thin layer of recoat material. The recoated splice can then be laid/centered in the channel 606 where it is pressed and cured in place. The rectangular channel above can then be back-filled with low-index recoat material applied, for example, using a syringe dispenser. Air-bubbles can be removed with a vacuum-pick before curing. A sealant can be placed over the low-index recoat material before the top portion 604 is fastened to the bottom portion 602 (i.e., before lidding). This sealant can minimize or reduce the out-gassing from the recoat material.

The kilowatt-class encapsulated splice techniques and structures described above have been validated under the following conditions:
vibration loads of 23.6 Grms;
thermal cycle: 10 cycles-20 to 65° C.; and
vacuum bake-out: 80° C. for 5 days at 1e-6 Torr.

The disclosed process and assembly represent an improvement over existing practices. The current state-of-the-art fiber amplifier and/or laser technology employs a splice suspended over a channel where air-convention is the main heat transfer mechanism. Any application where air is not present for cooling would lead to thermal run-away on the bare glass component. The process detailed above allows for a direct heat transfer path through the encapsulant to the metal. Also, the encapsulant acts as a shock absorber making the component more robust for applications where there could be significant vibration loads. Therefore, the disclosed technique and assembly are well-suited for fielded applications. With existing splice techniques used fiber amplifier technology, a main failure point is with the kW-class splice between the multimode combiner and the Ytterbium-doped fiber. In contrast, the disclosed techniques and structures can be applied to achieve yield of about one hundred percent.

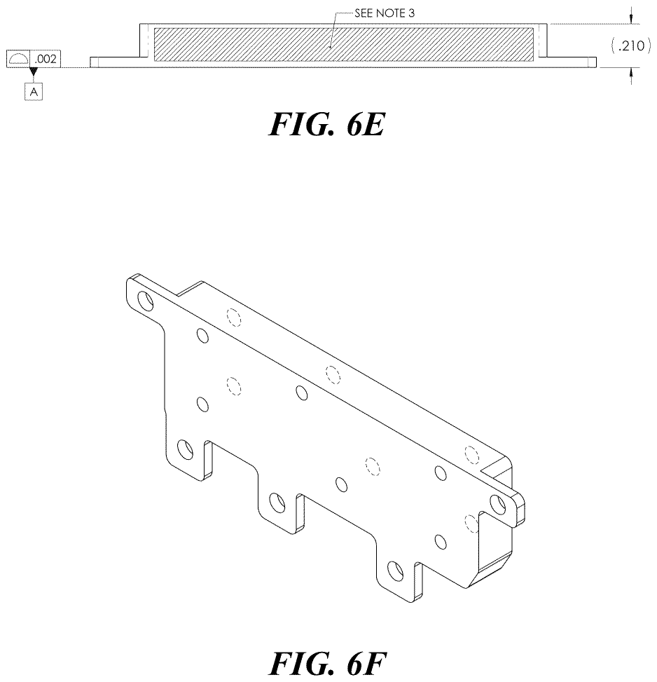

FIGS. 7A and 7B respectively illustrative an electrical pulse 700 (or “input pulse”) and a resulting optical pulse 720 (or “output pulse”) generated using direct-current modulation. In more detail, electrical pulse 700 may correspond to an electrical pulse generated by a seed laser driver (e.g., driver 103 of FIG. 1) and applied to a laser diode, for example. Pulse generation by direct current modulation of semiconductor lasers is important for seeding pulsed fiber laser amplifiers. Direct current modulation refers to shaping the pulse of the seed laser by directly applying a current pulse of the desired shape to the seed laser diode. As previously discussed, while this approach to pulse generation compares favorably to external modulation in terms of complexity, size, maintenance and cost, it may come with certain compromises.

One of these compromises, shown in FIG. 7B, is the presence of a gain-switching peak 722 at the leading edge of the output pulse 720. It is appreciated herein that the presence of such a peak 722 can be detrimental to system performance because it is relatively short in duration and its magnitude is not easily controllable. This issue is further problematic once the pulse is amplified in the system. The leading edge of the pulse is preferentially amplified by the fiber amplifier, which means that these peaks of varying height can be amplified to even higher peak powers. High peak powers can be damaging to a fiber amplifier, so this is especially concerning if the amplifier is being operated at the thresholds of their performance. In addition, such a peak 722 causes a reduction in optical gain the main pulse would otherwise have.

It is appreciated herein that a quick transition from the base 702 to the peak 704 of the electrical pulse 700 results in the highly peaked leading-edge pulse 720, such as shown in FIG. 7B.

Embodiments of the present disclosure improve the output pulse shape of a semiconductor laser by suppressing the gain-switching peak through careful selection of the input pulse shape/waveform (e.g., by providing smoother pulse transition). By suppressing such a peak, the use case of direct-current modulated semiconductor lasers is broadened to applications for which a smooth pulse transition is important.

In more detail, it is recognized herein that it is possible to minimize the effect of this quick transition by modifying the input pulse shape/waveform to include a shallow pedestal before the leading edge of the electrical pulse. The pedestal is referred to herein as a gain switching peak suppression (GSPS) pedestal.

Two parameters, or coefficients, may be considered in designing the GSPS pedestal: the slope (M) of the pedestal and the voltage level (L) at which the pedestal of slope M reaches (e.g., intersects) the base of the pulse. The pedestal level L may also be referred to as an offset. The specific slope and level of the leading-edge pedestal can be selected based on various factors, such as the particular laser module used (e.g., laser diode part), the particular seed laser driver or electronic components comprised therewithin, operating temperature, etc.

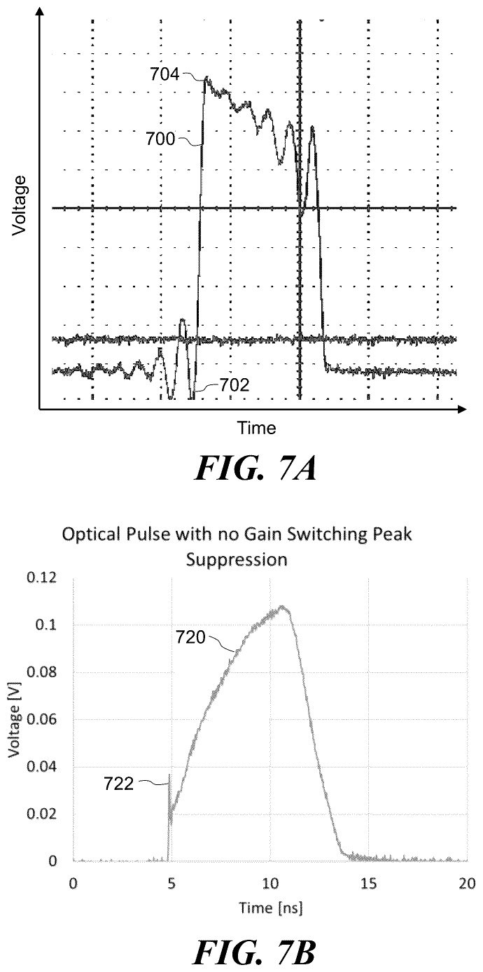

FIGS. 8A and 8B illustrate several different electrical pulse waveforms having GSPS pedestals with different L and M parameters. In FIG. 8A, a plot 800 illustrates five (5) waveforms 802a,b,c,d,e having the same slope (M=12.5 mV/ns) and different levels L=140, 120, 100, 80, 40 mV, respectively. In FIG. 8B, a plot 820 illustrates five (5) waveforms 822a,b,c,d,e having the same level (L=120 mV) and with different slopes M=10, 12.5, 15, 25, 50 mV/ns, respectively. The waveforms 802 of FIG. 8A may be generated by a user-programmable seed laser diode, for example.

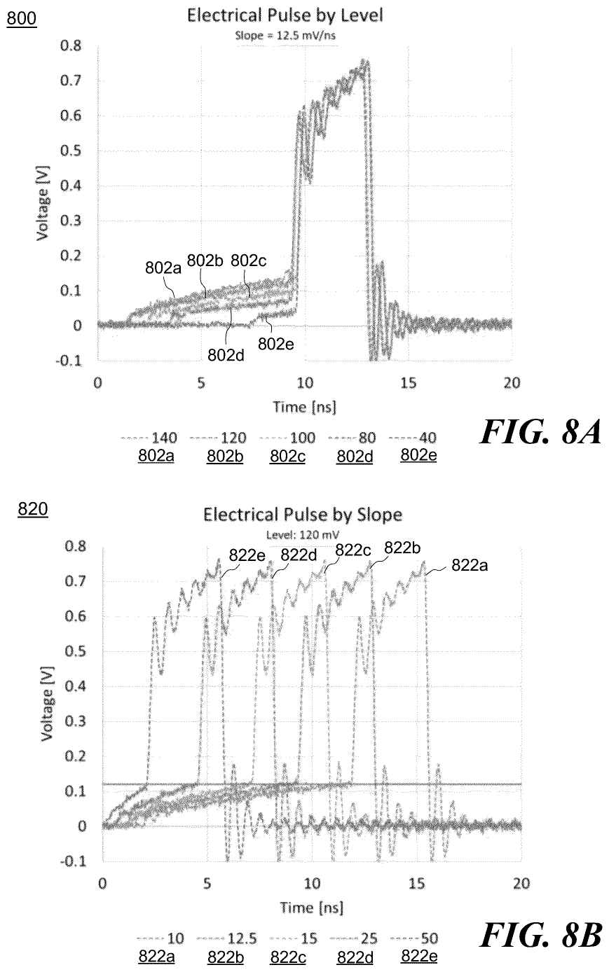

In FIG. 9, a plot 900 shows optical pulse output by the laser module as the pedestal slope (M) and offset (L) of the electrical pulse input is varied to suppress the gain-switching peak. A first optical pulse 902a results from an electrical pulse with no GSPS pedestal. Four (4) other optical pulses 902b,c,d,e can result from electrical pulses having GSPS pedestals with the following parameters: M=5 mV/ns and L=40 ns for pulse 902b; M=10 mV/ns and L=80 ns for pulse 802c; M=15 mV/ns and L=100 ns for pulse 902d; and M=20 mV/ns and L=120 ns for pulse 902e.

In some embodiments, a calibration or optimization procedure may be used to select the GSPS parameters for a particular target system design, instantiation, and/or operating environment. For example, an optimal state for gain-switching peak suppression may be achieved by increasing the slope (M) and offset (L) in incremental steps until the target waveform is optimized (i.e., as close to a waveform of the shape desired which also has no gain-switching peaks). Of note, if the value M and/or L is too high, the pedestal may become evident in the resulting optical pulse waveform. In the example of FIG. 9, it can be seen that optical pulse 902e shows no evidence of a gain-switching peak, indicating that the corresponding electrical pulse with GSPS pedestals parameters of M=20 mV/ns and L=120 ns may be optimal for the target system.

In some embodiments, the calibration/optimization procedure may select for a pulse that is continuous in time (the presence of a gain-switching peak would represent a discontinuity). A first derivative of the selected pulse would then be continuous also where one with a discontinuity would have a delta function present at the location of the discontinuity.

This described concepts and techniques provide a significant improvement in the optical pulses generated by direct-current modulation.

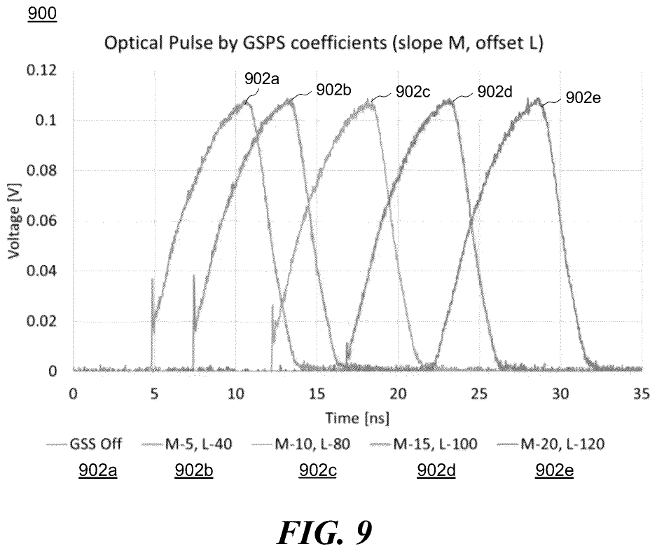

Turning to FIG. 10, high-peak power fiber amplifiers are generally composed of multiple gain stages, with a preamplifier stage preceding a final high-power gain stage (e.g., stages 110 and 112 in FIG. 1). Large mode area fibers (e.g., trench fiber) can be used to increase peak power handling high-power amplifiers. For the final amplifier stage (i.e., the high-power gain stage), a specialty large mode area fiber may be used, such as a fiber manufactured by Institut National d'Optique (INO).

FIG. 10 shows a profile of a trench fiber 1000 having a core 1002 to carry signal light and a cladding 1004 to carry pump light. Trench fiber 1000 may, for example, correspond to the gain fiber within high-power gain stage 112 of FIG. 1 (i.e., the final amplification stage). The fiber 1000 can optionally include stress rods 1006a, 1006b for maintaining polarization. In order to optimize peak power handling while maintaining near single-mode operation, the index of refraction of the cladding 1004 can be depressed just outside the core. For example, a depressed cladding 1005 can be disposed around the core 1002. Depressed cladding 1005 can be comprised of glass that is doped to lower its index of refraction. The core diameter of the fiber can be adiabatically tapered from, as discussed below. In some cases, the core 1002 can be co-doped with phosphorous to minimize photodarkening.

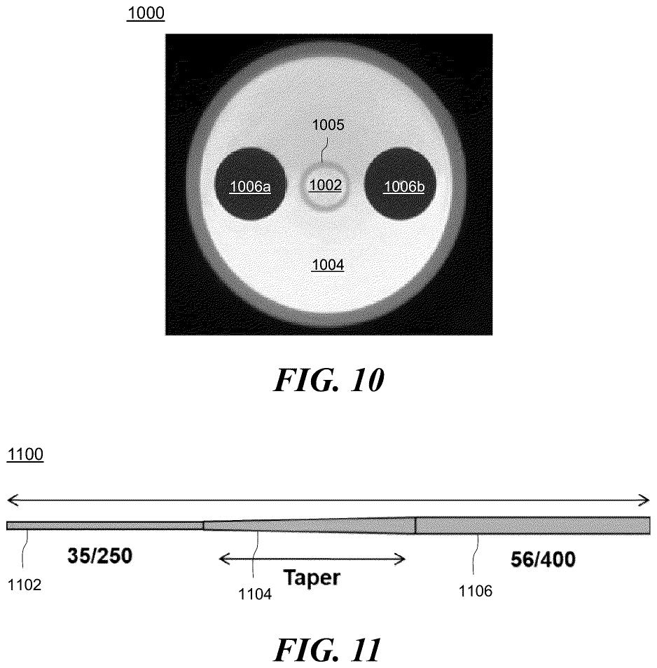

FIG. 11 schematically shows an example of a trench fiber 1100 having a tapered design, according to some embodiments. The illustrative fiber 1100 has three sections: an input section 1102, a tapered middle section 1104, and a final section 1106. The diameter of the core and cladding can be smaller within the input section 1102 compared to within the final section 1106. For example, input section 1102 can have a core diameter of 35 μm and a cladding diameter of 250 μm, whereas final section 1106 can have a core diameter of 56 μm and a cladding diameter of 400 μm. The middle section 1104 is tapered between these different diameters. In some cases, the length of the tapered middle section 1104 can be about 0.75 m.

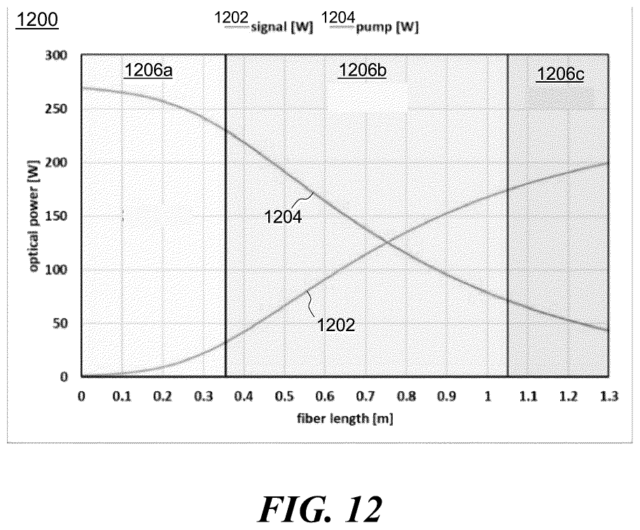

Turning to FIG. 12, in some embodiments, simulations of the amplifier performance can be used to determine the optimal fiber lengths and input powers in order to maximize efficiency and minimize nonlinear effects. A plot 1200 shows signal power 1202 and pump power 1204 plotted over the length of a trench fiber having an input section 1206a, a tapered section 1206b, and a final section 1206c. In this example, the input section has a core diameter of 35 μm and a cladding diameter of 250 μm, and the final section has a core diameter of 56 μm and a cladding diameter of 400 μm. The general techniques described can be applied to other core and cladding diameters. From simulation, it can be seen that that optimal length of the 35/250 section of fiber is 0.3 m and the optimal length of the 56/400 section of fiber is 0.25 m. Any variation in the taper length should be accounted for in the input and output sections in order to achieve a total length of 1.3 m. An input signal power of 2 W can reduce and ideally minimize the generation of forward and backward amplified spontaneous emission (ASE).

The described trench fiber's large mode area, short length, and adiabatic taper allow it to handle high peak power while maintaining desirable beam quality, which is a clear advantage over other commercially available fibers. The trench fiber length and input power parameters maximize efficiency while minimizing nonlinear phase accumulation (by minimizing the intensity×length product).

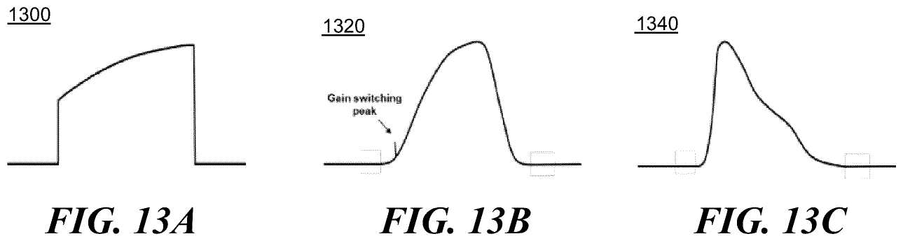

FIG. 13A shows an example of electrical pulse 1300 (or “input pulse”) that can be applied to a seed laser driver, FIG. 13B illustrates an optical pulse 1320 that can be output by a seed laser in response to the electrical pulse of FIG. 13A, and FIG. 13C shows an amplified pulse 1340 that can result from amplification of the optical pulse of FIG. 13B using a trench fiber. As seen in FIGS. 13A-C, the pulse travelling through the trench fiber can experience leading edge amplification, whereby the leading edge of a pulse depletes the gain in the fiber and as a result is amplified more than the trailing edge. This leads to an amplified pulse that has a significantly different shape when compared to the input pulse. If the output pulse becomes narrow enough, the peak power in the fiber can lead to nonlinearities.

To reduce and ideally avoid nonlinearities, pulse shaping can be implemented. In some embodiments, the duration of the input pulse can be made longer than the desired output pulse (e.g., 8 ns input pulse for a 5 ns output pulse) and/or biased with higher power at the trailing edge of the pulse. This can reduce and ideally minimize the gain switching peak of the seed diode. In some cases, the amount of extended duration of the input pulse duration can be determined in an iterative manner. Likewise, parameters used to bias the training edge of the pulse can be determined in an iterative manner.

As used in the claims or elsewhere herein, the term “comprising” does not exclude other elements or steps, and the indefinite article “a” or “an” does not exclude a plurality.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

Various embodiments of the concepts systems and techniques are described herein with reference to the related drawings. Alternative embodiments can be devised without departing from the scope of the described concepts. It is noted that various connections and positional relationships (e.g., over, below, adjacent, etc.) are set forth between elements in the claims, detailed description, and drawings. These connections and/or positional relationships, unless specified otherwise, can be direct or indirect, and the claimed inventions are not intended to be limiting in this respect. Accordingly, a coupling/connection of entities can refer to either a direct or an indirect coupling/connection, and a positional relationship between entities can be a direct or indirect positional relationship. As an example of an indirect positional relationship, references in the present description to element or structure A coupled/connected to element or structure B include situations in which one or more intermediate elements or structures (e.g., element C) is provided between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the detailed description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

Other variations to the disclosed embodiments can be understood and effected by those skilled in the art in practicing the claimed invention, from a study of the drawings, the disclosure, and the appended claims.

The mere fact that certain measures are recited in mutually different dependent claims does not indicate that a combination of these measures cannot be used to obtain an advantage.

Any reference signs in the claims should not be construed as limiting the scope.

All publications and references cited herein are expressly incorporated herein by reference in their entirety.

1. A pulsed fiber laser system comprising:
a seed laser configured to generate signal light comprising optical pulses; and
a pump signal combiner configured to receive the signal light via at least a first fiber and configured to optically combine the signal light within the at least first fiber with pump light;
a gain stage comprising one or more fiber amplifiers connected by at least one second fiber; and
an encapsulated splice assembly optically coupling the at least first fiber to the at least one second fiber.

2. The system of claim 1 wherein pump signal combiner comprises a kW-class multimode combiner.

3. The system of claim 1 wherein the at least one second fiber comprises Ytterbium-doped active fiber.

4. The system of claim 1 wherein the encapsulated splice assembly is formed of metal.

5. The system of claim 4 wherein the metal is coated with a chemical film.

6. The system of claim 1 wherein the encapsulated splice assembly comprises:
a top portion;
a bottom portion configured to be fastened to the top portion, the bottom portion including a u-shaped channel to receive the at least first fiber and the at least one second fiber; and
a rectangular channel disposed above the u-shaped channel, the rectangular channel filled with a low-index recoat material.

7. The system of claim 1 wherein:
the seed laser includes:
a driver configured to generate electrical pulses, and
at least one laser diode configured to generate optical pulses in response to the electrical pulses; and
the gain stage is configured to amplify the optical pulses; and
the electrical pulses are shaped to suppress gain-switching peaks within the optical pulses.

8. The system of claim 7 wherein the electrical pulses have a pedestal on their leading edges.

9. The system of claim 8 wherein the pedestal has a slope (M) and a voltage level (L) at which the pedestal intersects a base of the electrical pulses.

10. The system of claim 9 wherein M and L are optimized for the suppression of the gain-switching peaks within the optical pulses.

11. The system of claim 7 wherein the seed laser is configured to reduce spectral broadening within the optical pulses.

12. The system of claim 1 wherein the one or more fiber amplifiers includes a trench fiber having:
a core to carry signal light; and
a cladding to carry pump light,
wherein an index of refraction of the cladding is depressed in a region around a diameter of the core.

13. The system of claim 12 wherein the depressed region of the cladding is doped to have a lower index of refraction compared to other regions of the cladding.

14. The system of claim 12 wherein the diameter of the core is tapered along a length of the trench fiber.

15. The system of claim 12 wherein the core is doped with phosphorous.

16. A method for optically coupling a first fiber to a second fiber, the method comprising:
forming a strip interface on both the first fiber and the second fiber;
performing a pre-splice cleaning to remove residual coating and contaminates from both the first fiber and the second fiber;
splicing the first fiber to the second fiber at their respective strip interfaces to provide a spliced fiber;
performing a post-splice cleaning to remove contaminates from the spliced fiber resulting from the splicing;
recoating at least a portion of the spliced fiber using a recoat material;
encapsulating the spliced fiber within an encapsulated splice assembly; and
backfilling at least a portion of the spliced fiber within the encapsulated splice assembly using the recoat material.

17. The method of claim 16 wherein the first fiber and/or the second fiber have a fluoroacrylate coating, wherein the forming of the strip interface on the first fiber and/or the second fiber leaves the fluoroacrylate coating structurally intact around a diameter of the first fiber and/or the second fiber.

18. The method of claim 16 wherein the splicing of the first fiber to the second fiber comprises using a splice machine with a recipe to both:
maintain waveguide properties the first and second fiber for signal propagation; and
enable pump propagation through a junction of the spliced fiber.

19. The method of claim 16 wherein the recoat material comprises low-index fluoroacrylate.

20. The method of claim 16 wherein the performing of the post-splice cleaning includes wiping bare glass of the spliced fiber with Acetone, Ethanol, and/or Methanol.
